(19) United States
(12) Patent Application Publication
(10) Pub. No.: US 2007/0125888 A1
(43) Pub. Date: Jun. 7, 2007

(54) MULTI-COMPONENT LIQUID SPRAY SYSTEMS

(75) Inventors: Daniel J. Zillig, Cottage Grove, MN (US); Subramanian Krishnan, St. Paul, MN (US); William J. Kopecky, Hudson, WI (US); Stanley C. Erickson, Scandia, MN (US); Steven O. Ward, Omaha, NE (US); James C. Breister, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/561,940

(22) Filed: Nov. 21, 2006

Related U.S. Application Data
(60) Provisional application No. 60/748,233, filed on Dec. 1, 2005.

(51) Int. Cl. B05B 1/20

(52) U.S. Cl. 239/566; 239/550

(57) ABSTRACT

Multi-component liquid spray systems having a first array of first component spray nozzles and a second array of second component spray nozzles are provided. Each of the first component spray nozzles is adjacent at least one of the second component spray nozzles. Spray systems having co-aligned and parallel-aligned linear arrays of nozzles are described. Methods of making such spray systems and methods of using them to produce both multi-component sprays and coated articles are also described.

This application claims the benefit of U.S. Provisional Patent Application No. 60/748,233, filed Dec. 1, 2005, the disclosure of which is incorporated by reference herein in its entirety.

### FIELD

The disclosure relates generally to multi-component liquid spray systems and methods of applying a substantially uniform ratio of a first component and a second component onto a substrate.

### SUMMARY

Briefly, in one aspect, the present disclosure provides a multi-component liquid spray system comprising: an air chamber defined by a cavity in a housing and bounded on one side by a member comprising a plurality of orifices; a first array of first component spray nozzles, wherein each of the first component spray nozzles protrudes through an orifice in the member; and a second array of second component spray nozzles, wherein each of the second component spray nozzles protrudes through an orifice in the member; and wherein each of the first component spray nozzles is adjacent at least one of the second component spray nozzles.

In some embodiments, the first array of first component spray nozzles is a first linear array, and the second array of second component spray nozzles is a second linear array. In some embodiments, the first linear array of first component spray nozzles is co-aligned with the second linear array of second component spray nozzles. In some embodiments, the first linear array of first component spray nozzles is parallel to the second linear array of second component spray nozzles. In some embodiments, each of the second component spray nozzles is offset from its nearest first component spray nozzle.

In some embodiments, each of the first component spray nozzles comprises a primary flow axis and an exit orifice, wherein the exit orifice of at least one of first component spray nozzles is beveled at an angle relative to its primary flow axis forming a beveled face. In some embodiments, each of the second component spray nozzles comprises a primary flow axis and an exit orifice, wherein the exit orifice of at least one of second component spray nozzles is beveled relative to its primary flow axis forming a beveled face. In some embodiments, the bevel faces of the first component spray nozzles converge with the bevel faces of the second component spray nozzles.

In another aspect, the present disclosure provides a multi-component liquid spray system comprising: an air chamber defined by a cavity in a housing and bounded on one side by a member comprising a plurality of orifices; a first array of first component spray nozzles, wherein each of the first component spray nozzles protrudes through an orifice in the member; a second array of second component spray nozzles, wherein each of the second component spray nozzles protrudes through an orifice in the member; and a third array of third component spray nozzles, wherein each of the third component spray nozzles protrudes through an orifice in the member; wherein each of the first component spray nozzles and each of the third component spray nozzles is adjacent at least one of the second component spray nozzles.

In some embodiments, the first array of first component spray nozzles is a first linear array, the second array of second component spray nozzles is a second linear array, and the third array of third component spray nozzles is a third linear array. In some embodiments, the first linear array of first component spray nozzles, the second linear array of second component spray nozzles, and the third linear array of third component spray nozzles are co-aligned. In some embodiments, the first linear array of first component spray nozzles is parallel to the third linear array of third component spray nozzles.

In yet another aspect, the present disclosure provides a method of producing a multi-component spray comprising: delivering a first component and a second component to a multi-component liquid spray system; using a first array of first component spray nozzles to produce a first spray of the first component; using a second array of second component spray nozzles to produce a second spray of the second component; and mixing at least a first portion of the first spray and at least a second portion of second spray.

In another aspect, the present disclosure provides a method of making a coated article comprising: delivering a first component and a second component to a multi-component liquid spray system; using a first array of first component spray nozzles to produce a first spray of the first component; using a second array of second component spray nozzles to produce a second spray of the second component; and impinging the first and second sprays on an article; wherein at least a portion of the first spray and a portion of the second spray are mixed before impinging on the article.

In another aspect, the present disclosure provides a method of making a multi-component liquid spray system comprising: forming the cavity in a housing; bounding the cavity on one side by a member comprising a plurality of orifices; positioning a second array of second component spray nozzles such that each of the second component spray nozzles protrudes through an orifice in the member; and positioning a first array of first component spray nozzles such that each of the first component spray nozzles protrudes through an orifice in the member and is adjacent at least one of the second component spray nozzles.

In yet another aspect, the present disclosure provides a multi-component liquid spray system comprising: an air chamber defined by a cavity in a housing; means for producing a first spray of a first component coupled to the housing; means for delivering the first component in fluid communication with the means for producing the first spray; means for producing a second spray of a second component coupled to the housing; and means for delivering the second component in fluid communication with the means for producing the second spray.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1a is a side view of an exemplary multi-component liquid spray system of the present disclosure.

FIG. 1b is a bottom view of the exemplary multi-component liquid spray system of FIG. 1a.

FIG. 1c is a partially exploded view of the exemplary multi-component liquid spray system FIG. 1a.

FIG. 1d is an expanded view of nozzles mounted to a nozzle plate according to some embodiments of the present disclosure.

FIG. 1e is a bottom view of an exemplary nozzle plate of the present disclosure.

FIG. 1f is an expanded view of a feed block and shim according to some embodiments of the present disclosure.

FIG. 2 is an exemplary air plate of the present disclosure that includes orifices having alignment features.

FIG. 3a is an exemplary spray nozzle of some embodiments of the present disclosure.

FIG. 3b is a bottom view of the exemplary spray nozzle of FIG. 3a.

FIG. 4 is an exemplary beveled spray nozzle of some embodiments of the present disclosure.

FIG. 5a shows two co-aligned linear arrays of nozzles protruding through the orifices of an air plate according to some embodiments of the present disclosure.

FIG. 5b shows three co-aligned linear arrays of nozzles protruding through the orifices of an air plate according to some embodiments of the present disclosure.

FIG. 5c shows two parallel linear arrays of nozzles protruding through the orifices of an air plate according to some embodiments of the present disclosure.

FIG. 6a shows two parallel linear arrays of nozzles protruding through the orifices of an air plate, wherein the nozzles are opposed to each other.

FIG. 6b shows two parallel linear arrays of nozzles protruding through the orifices of an air plate, wherein the nozzles are offset from each other.

FIG. 7a shows another exemplary multi-component liquid spray system of the present disclosure.

FIG. 7b shows one die half of the exemplary multi-component liquid spray system of FIG. 7a.

FIG. 7c shows a side view of the exemplary multi-component liquid spray system of FIG. 7a.

FIG. 8a is an exemplary first binary flow plate of some embodiments of the present disclosure.

FIG. 8b is an exemplary second binary flow plate of some embodiments of the present disclosure.

FIG. 9 shows an exemplary air plate of some embodiments of the present disclosure.

FIG. 10a shows converging beveled faces on two nozzles according to some embodiments of the present disclosure.

FIG. 10b shows diverging beveled faces on two nozzles according to some embodiments of the present disclosure.

FIG. 10c shows parallel beveled faces on two nozzles according to some embodiments of the present disclosure.

FIG. 11 shows a schematic illustration of the spraying and mixing of two components.

### DETAILED DESCRIPTION

Multi-component liquid spray systems are useful in a variety of applications including the coating of substrates, e.g., wide webs. In some applications, it may be desirable to deliver the multi-component liquid as a spray, i.e., material moving in a mass of dispersed drops. A variety of factors can limit productivity when delivering multi-component compositions as a spray including, e.g., premature interaction of the components, improper ratios of the components, purging requirements, and non-uniformity of the delivered composition.

In some multi-component liquid spray systems, various components are mixed prior to being delivered from the system. For example, the components may be mixed upstream of a nozzle used to produce a spray. Premature interaction of the components occurs when two or more of the components begin to interact (e.g., react) before exiting the spray system. The interaction of the components can lead to, e.g., a rise in viscosity (e.g., gelling), and/or solidification, which can plug downstream liquid passages, e.g., nozzles, in the liquid spray system.

When spraying multi-component mixtures, errors in the ratio of the components can occur. If multiple components are mixed in an undesired ratio prior to being discharged from the spray system, the improperly mixed composition must be purged from the spray system. Purging often leads to a substantial waste of resources including time and materials. Purging requirements also make changes in the desired coating composition, e.g., component ratios, inefficient and expensive.

Additional problems may arise when attempting to deliver a uniform ratio of two or more components across the width of a web. Generally, the spray pattern from typical liquid spray systems is not uniform. For example, the amount of material delivered to the web may be higher in the center or at the edges of the spray produced by a single nozzle. While this non-uniformity may be acceptable if the multiple components are mixed upstream of the nozzle, such non-uniform spray may be unacceptable when attempting to achieve a uniform ratio of components by combining the sprays produced by multiple nozzles. Similarly, if an array of nozzles is used to provide liquid across the width of a web, non-uniform spray patterns from the individual nozzles can lead to defects wherein the amount of liquid delivered to particular regions of the web is significantly greater or less than the average amount of liquid delivered across the width of the web which may result in, e.g., streaks and banding.

In one aspect, the present disclosure provides multi-component liquid spray systems capable of delivering a plurality of components such that some of the components are not mixed together until after they are discharged from the spray system. In some embodiments, the liquid spray systems of the present disclosure minimize or eliminate the premature interaction of components. In some embodiments, the liquid spray systems of the present disclosure reduce purging requirements. In some embodiments, the liquid spray systems of the present disclosure reduce the time and/or expense required to change the relative concentrations of the various components of a multi-component composition. In another aspect, the present disclosure provides multi-component liquid spray systems capable of delivering a uniform ratio of two or more components across the width of an article, e.g., a web. Other features and advantages of the present disclosure are described below.

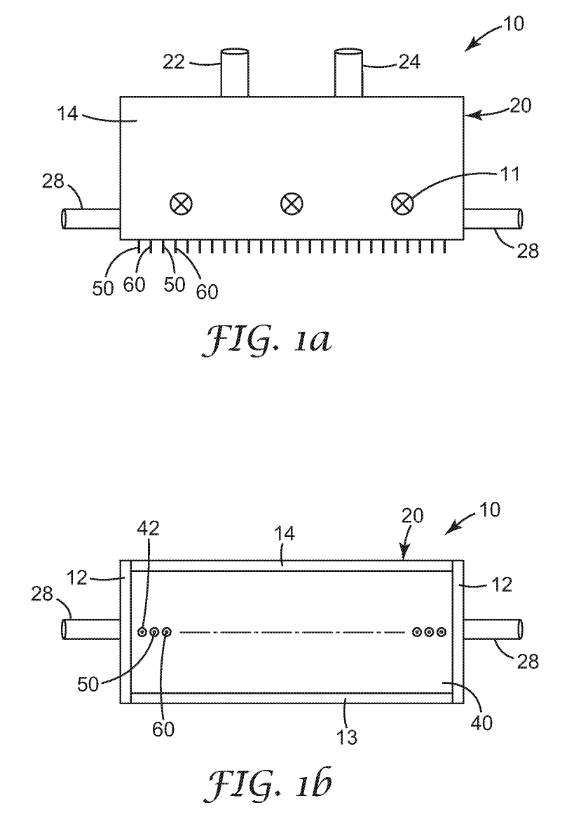

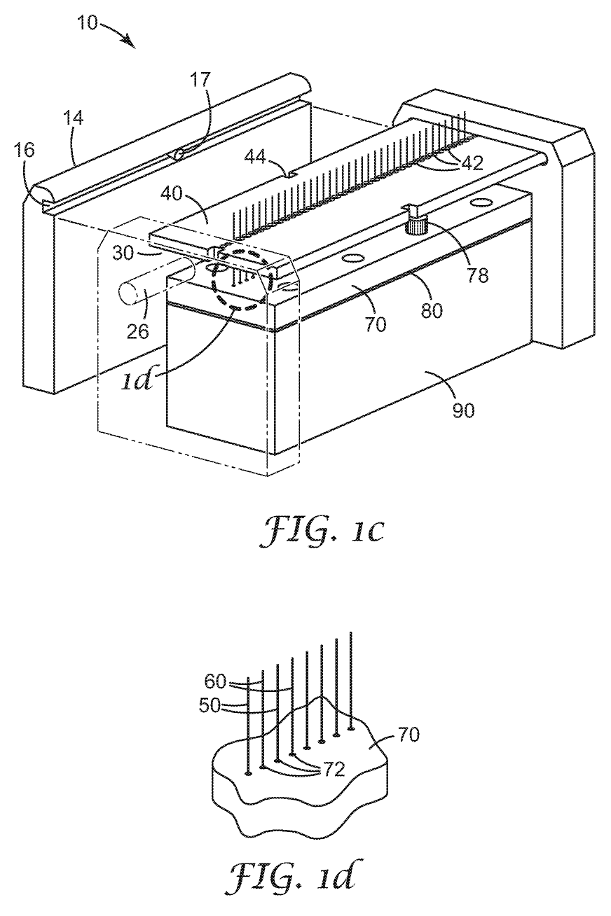

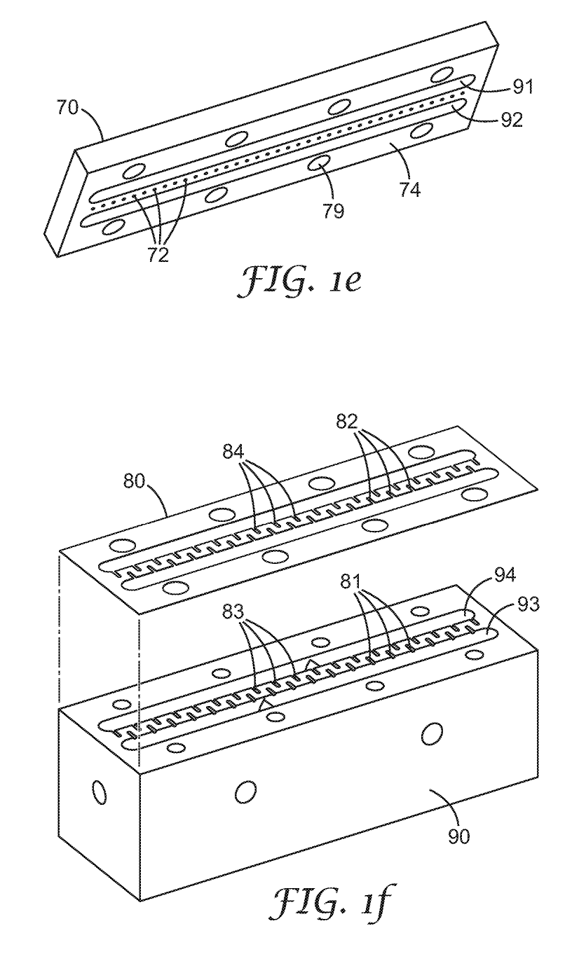

An exemplary multi-component liquid spray system of one embodiment of the present disclosure is shown in FIGS. 1a-1f. Generally, each part of the die may be formed from well-known materials such as metals and plastics. Exemplary materials include stainless steel and nylon. Selection of the materials used for each part is within the ordinary skill in the art. Depending on the application, factors affecting selection may include compatibility with the materials being sprayed, ease of manufacture, cost, corrosion resistance, abrasion resistance, thermal stability, and durability.

Referring to FIG. 1a, multi-component liquid spray system 10 comprises housing 20, first component spray nozzles 50, and second component spray nozzles 60. Housing 20 includes front panel 14, which is mounted to the feed block (not shown) by mounting bolts 11. Multi-component liquid spray system 10 also includes first component inlet port 22, second component inlet port 24, and air inlet ports 26. Selection of the numbers and locations of the various ports is a matter of routine design considerations and may be affected by, e.g., properties of the materials being delivered (e.g., density and viscosity), desired flow rates and distributions, the dimensions of the spray system, spatial constraints within the housing (e.g., desired liquid and/or air pathways), and spatial constraints outside the housing (e.g., desired locations of feed systems and mounting features).

As shown in FIG. 1b, in addition to front panel 14, housing 20 includes side panels 12 and back panel 13, each of which is attached to the feed block (not shown) by mounting bolts (not shown), and air plate 40. Each first component spray nozzle 50 and second component spray nozzle 60 protrudes through an orifice 42 in air plate 40. Orifices 42 are shown as circular orifices; however, they may be any shape including, e.g., geometric shapes (e.g., squares, triangles, or hexagons) and irregular shapes.

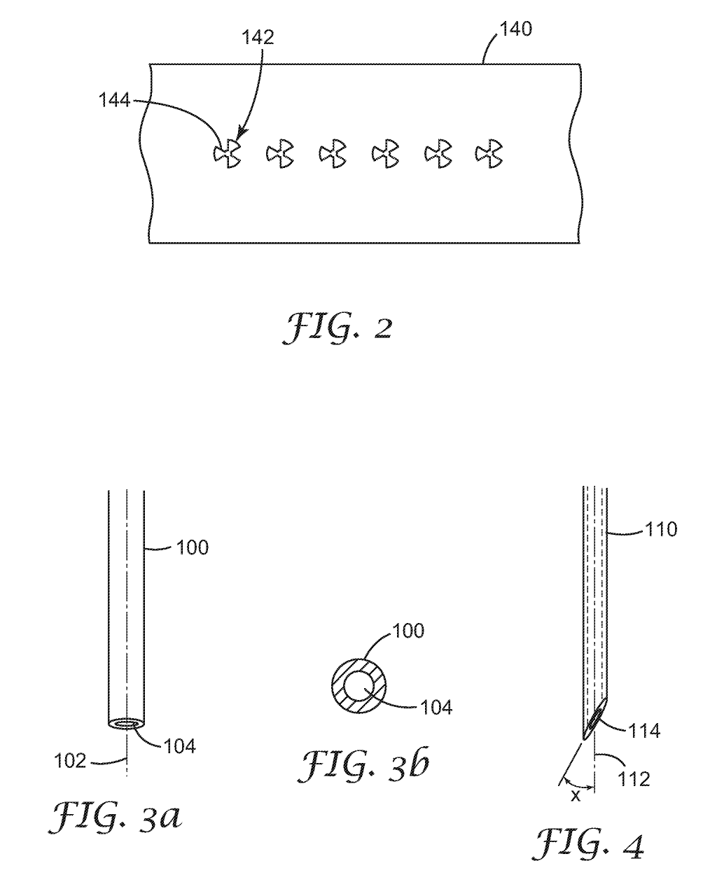

Referring to FIG. 2, a portion of air plate 140 including orifice 142 having alignment features 144 is shown. Generally, alignment features 144 are selected to aid in aligning a nozzle relative to the center of an orifice. In some embodiments, it may be desirable to position a nozzle concentrically within an orifice. In some embodiments, it may be desirable to offset the nozzle from the center of the orifice. Selection of the size, shape, and number of alignment features per orifice is a matter of routine design considerations and may depend on, e.g., the size and shape of the nozzle, the desired location of the nozzle, and the forces the nozzle will be subjected to during spraying (e.g., air and liquid pressures.

In some embodiments, the openings in an air plate may comprise one or more elongated orifices or slots. In some embodiments, only one nozzle protrudes through each orifice. In some embodiments, two or more nozzles may protrude through a single orifice. In some embodiments, there may be orifices through which no nozzles protrude.

Referring to FIG. 1c, a partially exploded view of multi-component spray system 10 is shown with the front panel removed. Back panel 14 has groove 16 for receiving an edge of air plate 40. Similar grooves are present in the front and side panels. Each groove 16 may include an alignment feature such as tab 17, which mates with a corresponding alignment feature in air plate 40 such as recess 44. Grooves 16 support air plate 40 a fixed distance from nozzle plate 70, forming air chamber 30.

Pressurized air enters air chamber 30 through air inlet ports 26. In some embodiments, gases or vapors other than air may be used, e.g., oxygen, nitrogen, carbon dioxide, and water vapor. Air chamber 30 is bounded on one side by air plate 40, which includes orifices 42 that allow air to pass from air chamber 30 into the ambient environment. Air chamber 30 is bounded on the opposing side by nozzle plate 70, which is mounted to feed block 90 by mounting bolts 78.

As shown in FIG. 1d, spray nozzles 50 and 60 are press fit into openings 72 of nozzle plate 70. Other means of attaching the nozzles in the openings of nozzle plate 70 may be used, e.g., threaded fittings, adhesives, and curable materials (e.g., epoxies).

Referring to FIGS. 1c, 1e and 1f, bottom surface 74 of nozzle plate 70 is separated from feed block 90 by gasket 80. Nozzle plate 70 and gasket 80 are attached to feed block 90 by mounting bolts 78. Generally, gasket 80 compensates for imperfections in the mating surfaces of nozzle plate 70 and feed block 90. If these surfaces were highly polished and free of pits and/or peaks, a gasket may not be necessary. However, even with highly polished surfaces, dust or debris present on either surface may prevent perfect seal from being formed and leakage may occur. Generally, gasket 80 is made of a compressible material such as a soft metal, e.g., copper; a polymeric film, e.g., polyester or nylon; silicone; rubber; or impregnated woven or nonwoven webs, e.g., rubber-impregnated webs.

Bottom surface 74 of nozzle plate 70, including through holes 79 for receiving mounting bolts 78, is shown in FIG. 1e. Openings 72 allow liquids comprising the first component and the second component to flow to the first component liquid nozzles, and the second component liquid nozzles, respectively. Openings 72 are positioned between first recess 91 and second recess 92. First recess 91, together with a corresponding recess in the feed block, forms a first liquid manifold. Similarly, second recess 92 forms a second liquid manifold when mated with its corresponding recess in the feed block. These corresponding recesses are shown in FIG. 1f.

Referring to FIG. 1f, feed block 90 comprises third recess 93, which, in combination with first recess 91 in nozzle plate 70, forms a first liquid manifold. Third recess 93 includes channels 81. Gasket 80 includes corresponding channels 82 such that, when gasket 80 is properly positioned on feed block 90, channels 81 and 82 will align forming passages directing material from the first liquid manifold to only those openings 72 in nozzle plate 70 that feed the first component spray nozzles. Similarly, feed block 90 comprises fourth recess 94, which, in combination with second recess 92 in nozzle plate 70, forms a second liquid manifold. Fourth recess 94 includes channels 83. Gasket 80 includes corresponding channels 84 such that, when gasket 80 is properly positioned on feed block 90, channels 83 and 84 will align forming passages directing material from the second liquid manifold to only those openings 72 in nozzle plate 70 that feed the second component spray nozzles.

Generally, a first liquid comprising the first component is fed into the first liquid manifold through the first component inlet port. The first liquid fills the first liquid manifold, flows through the passages formed by the channels in the feed block and shim, and is ejected from the first component spray nozzles. Similarly, a second liquid comprising the second component is fed into the second liquid manifold through the second component inlet port, filling it. The second liquid flows through the passages formed by the channels in the feed block and shim, and is ejected from the second component spray nozzles. Air (and/or other gases or vapors) flow from the air chamber through the orifices surrounding the first and second component spray nozzles. This air assists in the atomization of the first and second liquids as they exit the spray nozzles.

In some embodiments, the design of the nozzles and the manifold are selected to produce a significantly larger pressure drop down the length of each nozzle than down the length of each manifold. In some embodiments, the pressure at the inlet of each first nozzle is substantially constant along the length of the first manifold, and the pressure at the inlet of each second nozzle is substantially constant along the length of the second manifold. The pressure at the inlets of the first nozzles may be substantially the same, or different from the pressure at the inlets of the second nozzles.

A spray nozzle of one embodiment of the present disclosure is shown in FIGS. 3a and 3b. Nozzle 100 comprises a hollow tube having primary flow axis 102 and exit orifice 104. Exit orifice 104 is shown as a circle. Generally the exit orifice may have any cross-sectional shape including, e.g., elliptical, triangular, square, hexagonal, and octagonal. In some embodiments, irregularly shaped exit orifices may also be used. Regardless of the exit orifice shape, the hydraulic diameter, D_{H}, of the orifice is defined as four times the cross-sectional area of the orifice, A, divided by the wetted perimeter of the orifice, P, (i.e., D_{H}=4A/P). The hydraulic diameter of a circular orifice is equal to the diameter of the circle.

As shown in FIGS. 3a and 3b, exit orifice 104 of nozzle 100 is substantially perpendicular to primary flow axis 102. In some embodiments, the exit orifice is beveled relative to the primary flow axis forming a beveled face. For example, referring to FIG. 4, nozzle 110 having exit orifice 114 beveled at angle X relative to primary flow axis 112 is shown. Generally, any bevel angle may be used. In some embodiments, a bevel angle of at least 15°, and, in some embodiments, at least 20°, or even at least 30°, may be desired. In some embodiments, a bevel angle of no greater than 75°, and, in some embodiments, no greater than 60°, or even no greater than 40° may be desired. For convenience, when the exit orifice is beveled relative to the primary flow axis, the exit orifice shape, and its cross-sectional area and wetted perimeter are defined with reference to a plane perpendicular to the primary flow axis. That is, the cross-sectional area and wetted perimeter and, thus, the hydraulic diameter are defined by the shape the exit orifice would have were it not beveled.

In some embodiments, the first component spray nozzles will collectively form a first array of first component spray nozzles. Similarly, in some embodiments, the second component spray nozzles will collectively form a second array of second component spray nozzles. In some embodiments, an array of spray nozzles will be a linear array. As used herein, “linear array” includes an array wherein substantially all of the nozzles of the array are substantially aligned along a common axis. In some embodiments, at least 80%, in some embodiments, at least 90%, or even at least 95% of the nozzles in the array will be substantially aligned along a common axis. Generally, it is not feasible and/or practical to have even as few as three nozzles perfectly aligned along a common axis. As used herein, a nozzle is “substantially aligned” with a common axis if the distance between the geometric center of the nozzle's exit orifice and the common axis is less than twice the nozzle's hydraulic diameter. In some embodiments, the distance between the geometric center of a nozzle's exit orifice and the common axis will be less than one, and, in some embodiments, less than one-half times the nozzle's hydraulic diameter.

In some embodiments, a first linear array of first nozzles and a second linear array of second nozzles will be co-aligned. That is, the first nozzles and the second nozzles will be linearly aligned relative to common axis. In some embodiments, a first linear array of first nozzles and a second linear array of second nozzles will be co-aligned and the first and second nozzles will be interspersed. In some embodiments, the first and second nozzles will be interspersed such that each of the first nozzles is adjacent at least one of the second nozzles. In some embodiments, the first and second nozzles will alternate along the common axis.

In some embodiments, the distance between adjacent first and second nozzles will be no greater than twenty times the mean hydraulic diameter of the exit orifices of the first nozzles. In some embodiments, the distance will be no greater than ten, and in some embodiments no greater than five, or even no greater than three times the mean hydraulic diameter of the exit orifices of the first nozzles.

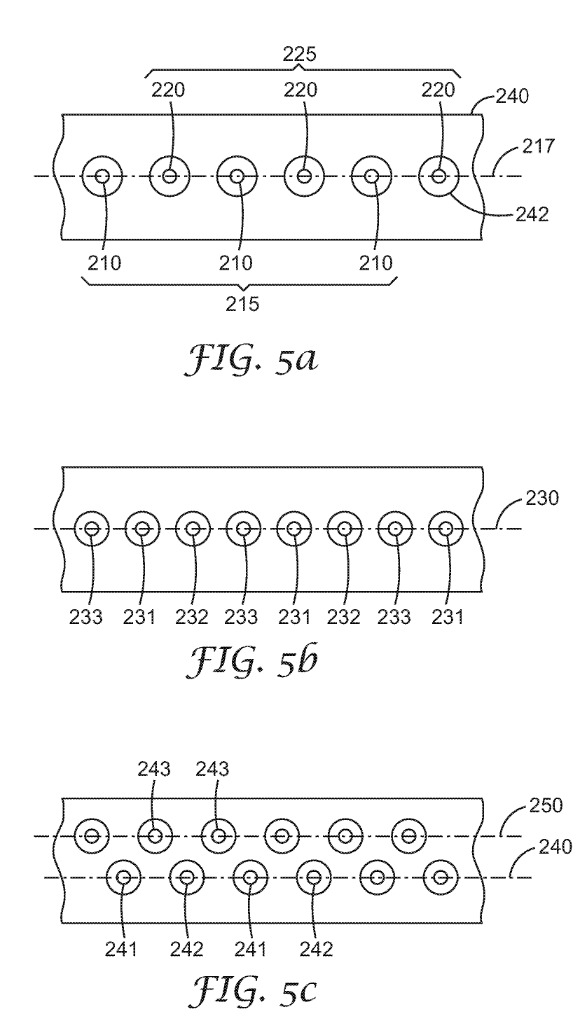

Referring to FIG. 5a, first array 215 of first component spray nozzles 210 and second array 225 of second component spray nozzles 220 are shown. First array 215 and second array 225 are linear arrays, with first component spray nozzles 210 and second component spray nozzles 220 aligned along common axis 217. Each of the first and second nozzles protrudes through an orifice 242 in air plate 240. First component spray nozzles 210 and second component spray nozzles 220 are interspersed such that each first nozzle 210 is adjacent at least one second nozzle 220.

In some embodiments, the liquid spray system may include a third array of third component spray nozzles. In some embodiments, the third array will be a linear array. In some embodiments, the third linear array will be co-aligned with the first or second linear arrays. In some embodiments, each of the third component spray nozzles will be adjacent to a first or second component spray nozzle. In some embodiments, the first, second, and third linear arrays of nozzles will be co-aligned along the same common axis. Referring to FIG. 5b, in some embodiments, the first, second, and third linear arrays of nozzles are co-aligned along common axis 230, wherein each first component spray nozzle 231 is adjacent both a second component spray nozzle 232 and a third component spray nozzle 233. In some embodiments, one or more additional arrays of spray nozzles may be included. In addition, other arrangements of the nozzles are possible.

In some embodiments, the first linear array of first nozzles will be aligned along a first common axis, and the second linear array of second nozzles will be aligned along a second common axis. In some embodiments, the first common axis will be substantially parallel to the second common axis. In some embodiments, the angle between the first common axis and the second common axis will be less than about 5°. In some embodiments, the angle will be less than about 3°, in some embodiments, less than about 2°, or even less than about 1°.

In some embodiments, the distance between the first common axis and the second common axis will be no greater than twenty times the average hydraulic diameter of the first nozzles. In some embodiments, the distance will be no greater than ten, and in some embodiments no greater than five, or even no greater than three times the mean hydraulic diameter of the exit orifices of the first nozzles.

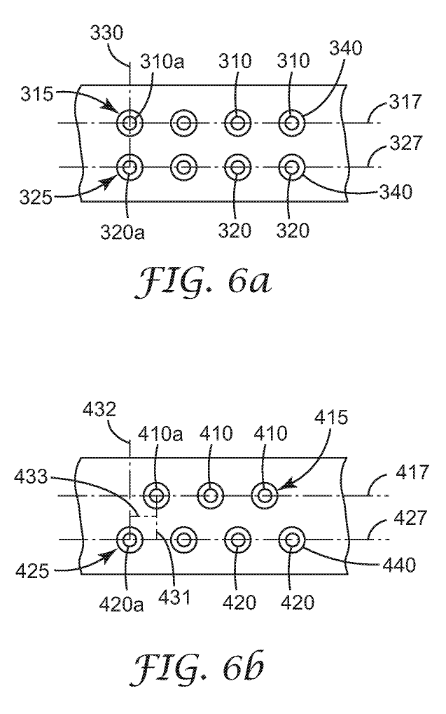

In some embodiments, substantially all (e.g., at least 80%, or at least 90%, or at least 95%, or even at least 99%) of the second nozzles of the second linear array will be opposed to a first nozzle of the first linear array. FIG. 6a shows first linear array 315 of first component spray nozzles 310 aligned along first common axis 317. Second linear array 325 is composed of second component spray nozzles 320 aligned along second common axis 327. Each of the first and second component spray nozzles protrudes through an orifice 340.

First common axis 317 and second common axis 327 are substantially parallel. Each second component spray nozzle 320 is opposed to a first component spray nozzle 310. A second component spray nozzle is opposed to a first component spray nozzle if a line drawn through the geometric center of the orifice of second component spray nozzle and perpendicular to the second common axis intersects the orifice of a first component spray nozzle. For example, second component spray nozzle 320a is opposed to first component spray nozzle 310a, as line 330, which passes through the geometric center of the orifice of second component spray nozzle 320a and is perpendicular to second common axis 327, intersects the orifice of first component spray nozzle 310a.

In some embodiments, substantially all (e.g., at least 80%, or at least 90%, or at least 95%, or even at least 99%) of the second component spray nozzles will be offset from all of the first component spray nozzles. FIG. 6b shows first linear array 415 of first component spray nozzles 410 aligned along first axis 417. Second linear array 425 is composed of second component spray nozzles 420 aligned along second common axis 427. First common axis 417 and second common axis 427 are substantially parallel. Each second component spray nozzle 420 is offset from each of the first component spray nozzles 410. A second component spray nozzle is offset from the first component spray nozzles if a line drawn through the geometric center of the orifice of second component spray nozzle and perpendicular to the second common axis does not intersect the orifice of any first component spray nozzle. For example, second component spray nozzle 420a is offset from its nearest first component spray nozzles 410a, as well as all other first component spray nozzles, as second line 432, which passes through the geometric center of the orifice of second component spray nozzle 420a and is perpendicular to second common axis 427, does not intersect the orifice of first component spray nozzle 410a, nor any other first component spray nozzle.

Referring to FIG. 6b, first line 431 passes through the geometric center of first component spray nozzle 410a and is perpendicular to second common axis 427. The amount of offset for second nozzle 420a relative to its nearest first component spray nozzle 410a is defined as the length of third line 433, which is perpendicular to both first line 431 and second line 432. Generally, for circular orifices, in order for second component spray nozzle 420a to be offset, this length must be greater than one-half the hydraulic diameter of the first component spray nozzle 410a. In some embodiments, the offset for substantially all (e.g., at least about 80%, or 90% or 95%, or even 99%) of the second nozzles relative to their nearest first component spray nozzle will be at least about one times, in some embodiments, at least about two times, in some embodiments, at least about three times, and even at least about five times, the average hydraulic diameter of the first component spray nozzles. In some embodiments, the amount of offset will be approximately equal to one-half the distance between adjacent second component spray nozzles.

In some embodiments, the liquid spray system may include a third array of third component spray nozzles. In some embodiments, the third array will be a linear array. In some embodiments, the third linear array will be co-aligned with the first or second linear array. Referring to FIG. 5c, in some embodiments, the first and second linear arrays of nozzles will be co-aligned along first common axis 240, with first component spray nozzle 241 alternating with second component spray nozzles 242. Third component spray nozzles 243 are aligned along second common axis 250. In some embodiments, first common axis 240 is substantially parallel to second common axis 250. In some embodiments, each of the third component spray nozzles is opposed to a first component spray nozzle or a second component spray nozzle. In some embodiments, each of the third component spray nozzles is offset from both the first component spray nozzles and the second component spray nozzles, as shown in FIG. 5c.

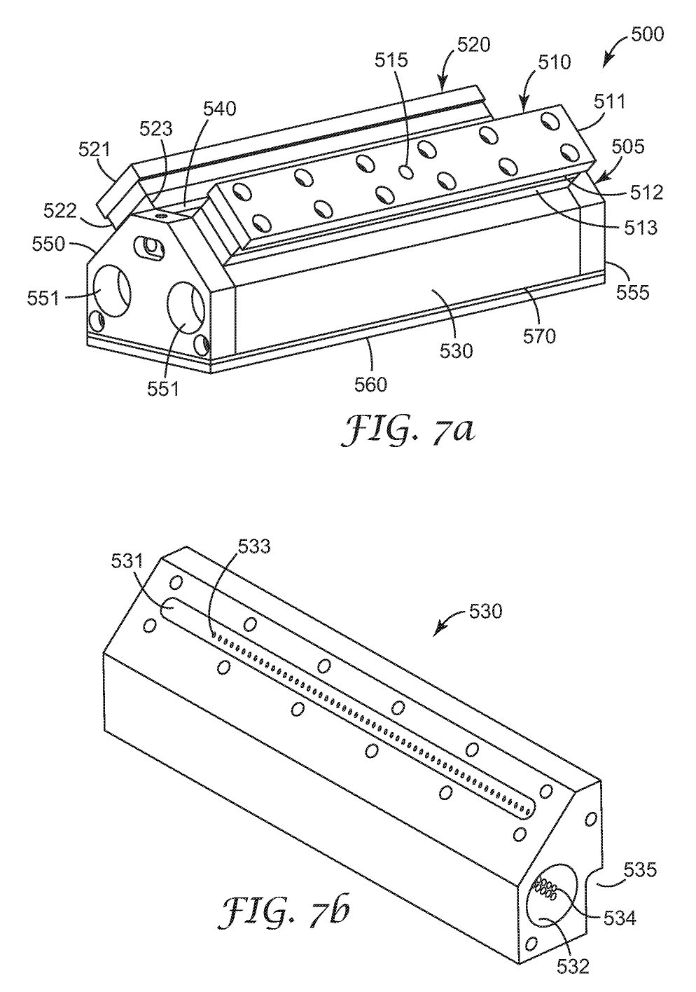

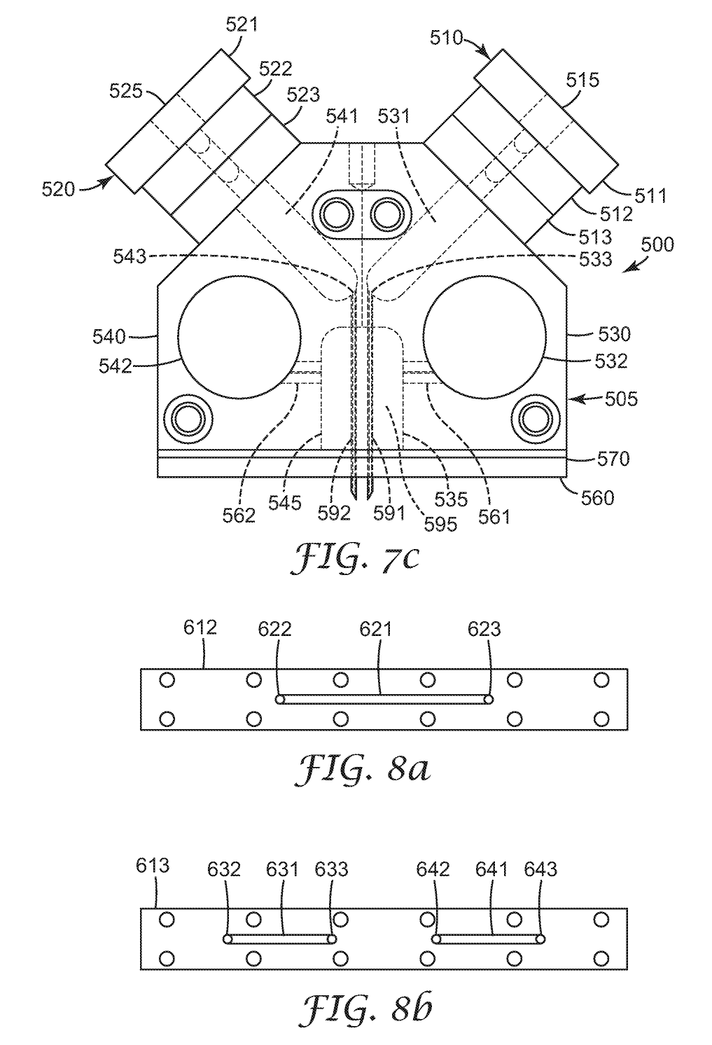

An exemplary multi-component liquid spray system of one embodiment of the present disclosure including parallel-aligned linear arrays of first and second component spray nozzles is shown in FIGS. 7a-7c.

Referring to FIG. 7a, multi-component liquid spray system 500 comprising housing 505 is shown. Housing 505 comprises end panels 550 and 555, first die half 530, and second die half 540. First component feed assembly 510 is attached to first die half 530, and comprises first feed plate 511, first binary plate 512, and second binary plate 513. First feed plate 511 includes at least one first component feed port 515. Similarly, second component feed assembly 520, comprising second feed plate 521, first binary plate 522 and second binary plate 523, is attached to second die half 540. Second feed plate 521 includes at least one second component feed port (not shown).

End panel 550 is attached to the first and second die halves by, e.g., bolts, and includes air inlet ports 551. End panel 555 is attached to the opposite end of the first and second die halves, and includes air outlet ports, not shown.

Air plate 560 is attached to one or more of the first and second die halves, and end panels 550 and 555. Optionally, air plate 560 may be separated from the die halves and end panels by one or more shims 570. In some embodiments, shims 570 may be used to adjust the distance between the bottom of air plate 560 and the tips of the nozzles protruding through the openings in the air plate.

Referring to FIG. 7b, first die half 530 comprises first liquid manifold 531 and first air manifold 532. First liquid manifold 531 includes openings 533, which allow a first liquid comprising a first component to flow from the first liquid manifold into a plurality of first component spray nozzles. First air manifold 532 includes openings 534, which allow air to flow from first air manifold 532 into the air chamber that is formed when first air recess 535 is mated with a corresponding air recess in the second die half. Openings 534 are shown as two rows of circular orifices. Other opening shapes (e.g., non-circular orifices and slots) and orientations (e.g., a single row, or more than two rows of orifices) may be used. In some embodiments, the design of the second die half will be similar to the design of the first die half. In some embodiments, the designs of the liquid manifolds, air manifolds, and their corresponding openings may be different for the first and second die halves. Differences may be desired to accommodate differences in the liquid properties (e.g., viscosity, density, and reactivity), desired liquid flow rate ranges, and desired air flow rates.

Exemplary first binary flow plate 612 is shown in FIG. 8a. First binary flow plate 612 includes flow distribution channel 621 having first and second through ports 622 and 623. Generally, the first binary flow plate is aligned relative to a feed plate such that liquid passing through a feed port in the feed plate is directed near the center of the flow distribution channel. The liquid then flows along the channel to the first and second through ports, through these ports, and on to the second binary flow plate (if present). In some embodiments, the feed plate will have a plurality of feed ports. In some embodiments, first binary flow plate will have a single common flow distribution channel fed by all the feed ports. In some embodiments, the first binary flow plate will have multiple flow distribution channels, with each channel fed by at least one of the feed ports.

Exemplary second binary flow plate 613 is shown in FIG. 8b. Second binary flow plate 613 includes first flow distribution channel 631 having first and second through ports 632 and 633, and second flow distribution channel 641 having first and second through ports 642 and 643. In some embodiments, the second binary flow plate is aligned relative to a first binary flow plate such that liquid passing through each of the through ports in the first binary flow plate is directed near the center of a flow distribution channel in the second binary flow plate. The liquid then flows along the channel to the first and second through ports of the second binary flow plate, through these ports, and feeds either additional binary flow plates (if present) or the liquid manifold. In some embodiments, the multiple through holes in the first binary flow plate will feed a common distribution channel in the second binary flow plate. Generally, the number of binary flow plates present is a matter of routine design considerations and may depend on, e.g., the length of the die and liquid properties (e.g., viscosity and density).

Referring to FIG. 7c, an end view of multi-component liquid spray system 500 comprising first die half 530 and second die half 540 is shown. Generally, a first liquid comprising a first component will flow through first inlet port 515, pass though first binary plate 512 and second binary plate 513 and into first liquid manifold 531. The first liquid will then pass through openings 533 and into first component spray nozzles 591. First component spray nozzles 591 may be directly or indirectly connected to the first liquid manifold. In some embodiments, first component spray nozzles 591 are attached (e.g., press fit, threaded, or adhered) to openings 533. First component spray nozzles 591 pass through air chamber 595 and exit housing 505 through openings in optional air shim 570 and air plate 560.

Similarly, a second liquid comprising a second component will flow through second inlet port 525, pass though first binary plate 522 and second binary plate 523 and into second liquid manifold 541. The second liquid will then pass through openings 543 and into second component spray nozzles 592. Second component spray nozzles 592 may be directly or indirectly connected to the second liquid manifold. In some embodiments, second component spray nozzles 592 are attached (e.g., press fit, threaded, or adhered) to openings 543. Second component spray nozzles 592 pass through air chamber 595 and exit housing 505 through openings in optional air shim 570 and air plate 560.

Generally, adjusting the flow rates of air into the first and second air manifolds can control the pressure in the air chamber. Referring to FIG. 7c, air chamber 595 is formed by first air recess 535 and second air recess 545. First air manifold 532 is in direct fluid communication with air chamber 595 via air passage 561. Similarly, second air manifold 542 is in direct fluid communication with air chamber 595 via air passage 562. In some embodiments, one or more additional air manifolds may be positioned between the first and/or second air manifold and the air chamber. Additional air manifolds may be useful in establishing a uniform pressure in the air chamber.

In some embodiments, the housing may include a member splitting the air chamber into two portions. The first component spray nozzle would pass through the first portion of the air chamber and the second component spray nozzles would pass through the second portion of the air chamber. In such an embodiment, the air pressure in the first portion can be adjusted independently of the air pressure in the second portion by, e.g., controlling the flow rates of air into the first and second air manifolds.

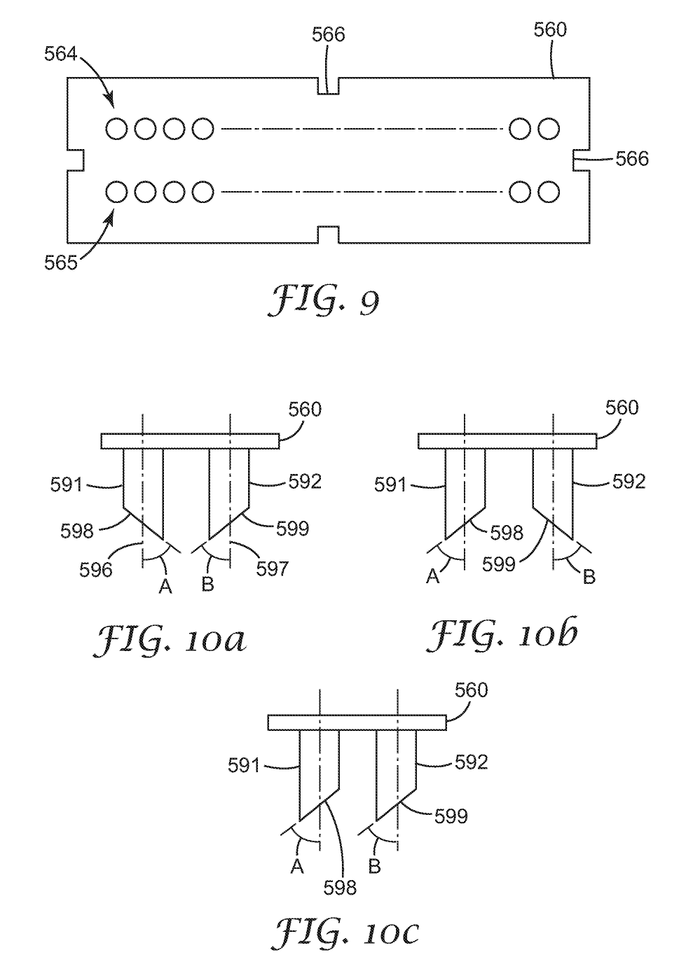

Air plate 560 is shown in FIG. 9. Air plate 560 includes notches 566, which receive corresponding tabs in the die halves and end plates, aid in aligning and restraining the air plate. Other methods may be used to attach an air plate to the remainder of the housing including, e.g., mechanical fasteners and adhesives. Air plate 560 also includes a first array of first orifices 564 and a second array of second orifices 565. In some embodiments, the first array and/or the second array of orifices are linear arrays. In some embodiments, the first linear array of first orifices is substantially parallel to the second linear array of second orifices. Generally, at least one of the first component spray nozzles passes through each first orifice 564, and at least one of the second component spray nozzles passes through each second orifice 565. In some embodiments, one or more of the first and/or second orifices may not have a nozzle passing through it. In some embodiments, one or more of the first and/or second orifices may have a plurality of nozzles passing through it.

As shown in FIG. 9, each of second orifices 565 is opposed to a first orifice 564. In some embodiments, one or more of the second orifices will be offset from the first orifices. In some embodiments, substantially all of the second orifices will be offset from the first orifices. Generally, if a first and second orifice are opposed to each other, the corresponding first and second component spray nozzle passing through those orifices will be opposed. Generally, if a first and second orifice are offset from each other, the corresponding first and second component spray nozzles passing through them will be offset from each other.

In some embodiments, the orifices of each first component spray nozzle will be perpendicular to its primary flow axis. In some embodiments, the orifices of each second component spray nozzle will be perpendicular to its primary flow axis. In some embodiments, one or more of the first or second component spray nozzles will be beveled.

Referring to FIGS. 10a-10c, first component spray nozzles 591 and second component spray nozzles 592 are shown passing through air plate 560. Each first component spray nozzle 591 is beveled at angle A relative to its primary flow axis 596. Similarly, each second component spray nozzle 592 is beveled at an angle B relative to its primary flow axis 597.

In some embodiments, the bevel angle of all of the first component spray nozzles will be substantially the same. In some embodiments, the bevel angles of the first component spray nozzles will vary from nozzle to nozzle. In some embodiments, the bevel angle of all of the second component spray nozzles will be substantially the same. In some embodiments, the bevel angles of the second component spray nozzles will vary from nozzle to nozzle. In some embodiments, the bevel angles of the first component spray nozzles will be substantially the same as the bevel angle of the second component spray nozzles. In some embodiments, the bevel angle of the first component spray nozzles will be different than the bevel angle of the second component spray nozzles.

Referring to FIG. 10a, beveled faces 598 of first component spray nozzles 591 converge with beveled faces 599 of second component spray nozzles 592. Referring to FIG. 10b, beveled faces 598 of first component spray nozzles 591 diverge from beveled faces 599 of second component spray nozzles 592. Referring to FIG. 10c, beveled faces 598 of first component spray nozzles 591 are substantially parallel to the beveled faces 599 of second component spray nozzles 592. Other orientations of the bevel faces of the first component spray nozzles relative to the bevel faces of the second component spray nozzles are also possible. Generally, the bevel faces of all of the first component spray nozzles are oriented in the same direction. Generally, the bevel faces of all of the second component spray nozzles are oriented in the same direction. In some embodiments, the orientation of the bevel face may vary from nozzle to nozzle.

Generally, the multi-component liquid spray dies of the present disclosure may be used in any application where it is desirable to mix two or more components downstream of the die exit. In some embodiments, a first component and a second component are mixed downstream of the die exit. In some embodiments, a first liquid comprising a first component is atomized producing a first spray comprising a mass of dispersed drops of the first liquid. Similarly, in some embodiments, a second liquid comprising a second component is atomized producing a second spray comprising a mass of dispersed drops of the second liquid. In some embodiments, at least a portion of the drops of the first spray mix with a portion of the drops of the second spray in flight from the die exit to a substrate. In some embodiments, the first and second components interact, e.g., react, while the drops are in flight.

Generally, the first and second sprays impinge on the substrate forming a layer comprising the first and second liquids. In some embodiments, at least a portion of the first and second liquids do not mix until the liquids reach the substrate.

In some embodiments, the flow rates of the first and second liquids can be adjusted independently. In some embodiments, it may be desirable to control the ratio of a first component to a second component. Generally, the target ratio depends on the specific end use application and could be any value. For example, in some embodiments, the first and second components may react with one another, and the target ratio may be one. In some embodiments, a slight excess of first component to the second component may be desired, and the target ratio may be higher than one, e.g., 1.01, 1.1, 1.5, etc. In some embodiments, one component may be a catalyst and the desired amount of that component may be small leading to a target ratio of 0.5 or even less, e.g., 0.1, 0.05, or even 0.01.

In some embodiments, the first and second component may be non-reactive, e.g., dyes and other colorants. In some embodiments, it may be desirable to vary the ratios of the first and second components to vary the resulting color of the mixture of dyes or other colorants. For example, if the first component were a blue dye and the second component were a yellow dye, various shades of green could be obtained by varying the ratio of the first component (i.e., the blue dye) relative to the second component (i.e., the yellow dye). Generally, the multi-component spray dies of some embodiments of the present disclosure can be used to produce a uniform ratio of the first and second components across the entire length of the die. In some embodiments, the ratio of the first component to the second component is within 10% of the target ratio across the length of the die, in some embodiments, within 5%, in some embodiments, with 2%, and in some embodiments, within 1%, or even less, of the target ratio across the length of the die.

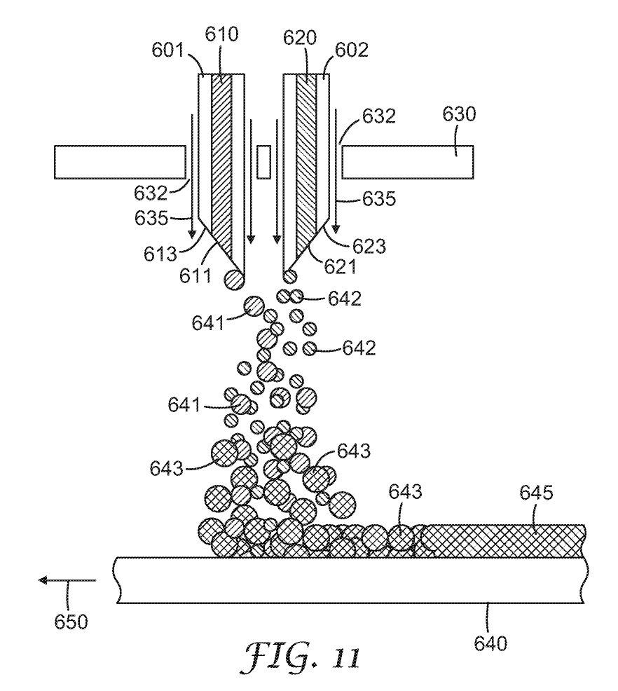

Referring to FIG. 11, first liquid 610, comprising a first component, flows through first component spray nozzle 601, which is part of a first linear array of first component spray nozzles. Similarly, second liquid 620, comprising a second component, flows through second component spray nozzle 602, which is part of a second linear array of second component spray nozzles. First component spray nozzle 601 includes exit orifice 611 located in beveled face 613. Second component spray nozzle 602 is opposed to first component spray nozzle 601 and includes exit orifice 621 located in beveled face 623. The first and second component spray nozzles are oriented such that their beveled faces converge.

First component spray nozzle 601 and second component spray nozzle 602 protrude through orifices 632 in air plate 630. Air flows from the air chamber, through orifices 632 and along the protruding lengths of the first and second component spray nozzles. As the first and second liquids are ejected from the exit orifices of the first and second component spray nozzles, respectively, this air assists in atomizing the liquids forming sprays, i.e., masses of dispersed drops. In some embodiments, the sprays are formed at the exit orifice. In some embodiments, the liquid may be expelled from the exit orifice as a column of liquid, which is formed into a mass of dispersed drops some distance downstream. In some embodiments, air is not required to produce a spray. For example, some liquids will atomize if discharged from the exit orifice at sufficient pressure.

The spray of the first liquid composed of drops 641 mixes with the spray of the second liquid, composed of drops 642. At least portions of the first component and the second component interact (e.g., mix and/or react) forming drops 643. Drops 641, 642 and 643 impinge on substrate 640 as it move beneath the nozzles in the direction indicated by arrow 650. In some embodiments, additional interaction between the first and second components occurs on substrate 640. Ultimately, the liquids impinging on substrate 640 coalesce forming uniform film of interacted first and second components 645.

In some embodiments, dies of the present invention can be mounted in a stationary position relative to a web or article. As the web or article moves past the spray die, the components will be applied in a substantially uniform ratio across a desired width of the web or article, up to and including the entire width of the web or article. In some embodiments, a single stationary die of the present invention can be used to apply a uniform ratio of components across a width of greater than 5 centimeters (cm), in some embodiments, greater than 25 cm, and in some embodiments, greater than 60 cm. In some embodiments, a single stationary die of the present invention may be used to apply a uniform ratio of components to wide webs or articles, i.e., webs or article having widths greater than 90 cm, greater than 150 cm, or even greater than 300 cm.

The following specific, but non-limiting, example will serve to illustrate one embodiment of the disclosure.

### EXAMPLE

The die shown in FIGS. 7a-7c, having needle row widths of 30.48 cm (12 inches), was used to mix and apply a blend of VERSALINK P-1000 oligomeric diamine (Air Products and Chemicals Inc., Allentown, Pa.) and PAPI 94 isocyanate (Dow Chemical USA, Midland, Mich.) at a 4.25:1.00 weight ratio.

The VERSALINK P-1000 was heated to 93° C. (200° F.) in a heated hopper that fed a 2.92 cubic centimeter/revolution metering gear pump (Parker Hannefin Corporation, Zenith Division, Sanford, N.C.). This gear pump was operated at 84 revolutions/minute, which produced a back-pressure of about 206.8 KPa (30 lbs./square inch). A neck tube having a 6.35 mm (0.25 inch) outside diameter (O.D.) and a 1.19 mm (0.047 inch) wall thickness was used to connect the gear pump to the inlet of one side of the die.

The PAPI 94 was not heated. It was fed to the other side of the die using a 1.20 cubic centimeter/revolution metering gear pump (Parker Hannefin Corporation, Zenith Division) that was operated at 41 revolutions per minute. This gear pump and die were connected using a 6.35 mm O.D.×1.19 mm wall thickness (0.25 inch O.D.×0.047 inch wall thickness) neck tube.

Thin tubes having an outside diameter of 1.524 mm (0.060 inch) and an inside diameter of 0.762 mm (0.030 inch) were beveled at an angle of approximately 45° on one end forming the first and second component spray nozzles. The first component spray nozzles were spaced 5.08 mm (0.200 inch) apart on centers within a row forming a first linear array of first component spray nozzles. Similarly, the second component spray nozzles were spaced 5.08 mm (0.200 inch) apart on centers within a row forming a second linear array of second component spray nozzles. The first linear array of first component spray nozzles was spaced 5.08 mm (0.200 inch) apart on centers from the second linear array of second component spray nozzles such that each first component spray nozzle was opposed a second component spray nozzle. The first and second component spray nozzles such that there beveled faces were converging.

Compressed air was heated to 121° C. (250° F.) and fed to the four air distribution manifold inlets at 124 KPa (18 psi). As the two components exited the ends of the nozzles, the compressed air caused them to atomize, mix and be blown onto a web that was passing under the die at a distance of about 63.5 mm (2.5 inches). Upon visual inspection, the web was uniformly coated and the input materials were well mixed. The composition, when cured, formed a tough, rubbery coating on the web.

Various modifications and alterations of this invention will become apparent to those skilled in the art without departing from the scope and spirit of this invention.

What is claimed is:

1. A multi-component liquid spray system comprising:
an air chamber defined by a cavity in a housing and bounded on one side by a member comprising a plurality of orifices;
a first array of first component spray nozzles, wherein each of the first component spray nozzles protrudes through an orifice in the member; and
a second array of second component spray nozzles, wherein each of the second component spray nozzles protrudes through an orifice in the member;
wherein each of the first component spray nozzles is adjacent at least one of the second component spray nozzles.

2. The multi-component liquid spray system of claim 1, further comprising a first manifold in fluid communication with a plurality of the first component spray nozzles and a second manifold in fluid communication with a plurality of the second component spray nozzles, optionally wherein the first manifold is in fluid communication with a first supply of a first component, and the second manifold is in fluid communication with a second supply of a second component.

3. The multi-component liquid spray system of claim 1, wherein each of the first component spray nozzles comprises a primary flow axis and an exit orifice, wherein the exit orifice of at least one of first component spray nozzles is beveled at an angle of between 15° and 75°, inclusive, relative to its primary flow axis, optionally wherein the exit orifices of substantially all of the first component spray nozzles are beveled at an angle of between 20° and 40°, inclusive, relative to their primary flow axes.

4. The multi-component liquid spray system of claim 1, wherein the first array of first component spray nozzles is a first linear array, and the second array of second component spray nozzles is a second linear array, and wherein the first linear array of first component spray nozzles is co-aligned with the second linear array of second component spray nozzles.

5. The multi-component liquid spray system of claim 4, wherein the center-to-center distance between a first component spray nozzle and its nearest second component spray nozzle is no greater than ten times the mean hydraulic diameter of the exit orifices of the first component spray nozzles.

6. The multi-component liquid spray system of claim 1, wherein the first array of first component spray nozzles is a first linear array, and the second array of second component spray nozzles is a second linear array, and wherein the first linear array of first component spray nozzles is parallel to the second linear array of second component spray nozzles.

7. The multi-component liquid spray system of claim 6, wherein the center-to-center distance between a first component spray nozzle and its nearest second component spray nozzles is no greater than ten times the mean hydraulic diameter of the exit orifices of the first component spray nozzles.

8. The multi-component liquid spray system of claim 6, wherein each of the second component spray nozzles is offset from its nearest first component spray nozzle, optionally wherein each of the second component spray nozzles is offset from its nearest first component spray nozzle by at least 40% of the distance between adjacent first component spray nozzles.

9. The multi-component liquid spray system of claim 6, wherein each of the first and second component spray nozzles comprises a primary flow axis and an exit orifice; wherein the exit orifices of substantially all of the first and second component spray nozzles are beveled at an angle of between 15° and 75°, inclusive, relative to their primary flow axes forming bevel faces.

10. The multi-component liquid spray system of claim 9, wherein the bevel faces of the first component spray nozzles converge with the bevel faces of the second component spray nozzles.

11. The multi-component liquid spray system of claim 1, wherein the air chamber is in fluid communication with a pressurized air source, and wherein an air manifold comprising a plurality of openings is positioned between the air chamber and the pressurized air source.

12. The multi-component liquid spray system of claim 1, further comprising a third array of third component spray nozzles, wherein each of the third component spray nozzles protrudes through an orifice in the member; and wherein each of the third component spray nozzles is adjacent at least one of the second component spray nozzles, optionally wherein the spray system further comprises a third manifold in fluid communication with a plurality of the third component spray nozzles, and optionally wherein the third manifold is in fluid communication with a third supply of a third component.

13. The multi-component liquid spray system of claim 12, wherein the first array of first component spray nozzles is a first linear array, the second array of second component spray nozzles is a second linear array, and the third array of third component spray nozzles is a third linear array, wherein the first linear array of first component spray nozzles, the second linear array of second component spray nozzles, and the third linear array of third component spray nozzles are co-aligned.

14. The multi-component liquid spray system of claim 12, wherein the first array of first component spray nozzles is a first linear array, the second array of second component spray nozzles is a second linear array, and the third array of third component spray nozzles is a third linear array, wherein the first linear array of first component spray nozzles is parallel to the third linear array of third component spray nozzles.

15. A method of producing a multi-component spray comprising:
delivering a first component and a second component to the multi-component liquid spray system of claim 1;
using the first array of first component spray nozzles to produce a first spray comprising the first component;
using the second array of second component spray nozzles to produce a second spray comprising the second component; and
mixing at least a first portion of the first spray and at least a second portion of second spray.

16. A method of making a coated article comprising:
delivering a first component and a second component to the multi-component liquid spray system of claim 1;
using the first array of first component spray nozzles to produce a first spray comprising the first component;
using the second array of second component spray nozzles to produce a second spray comprising the second component; and
impinging the first and second sprays on an article; wherein at least a portion of the first spray and the second spray are mixed before impinging on the article.

17. A method of making the multi-component liquid spray system of claim 1 comprising:
forming the cavity in the housing:
bounding the cavity on one side by the member comprising a plurality of orifices;
positioning the second array of second component spray nozzles such that each of the second component spray nozzles protrudes through an orifice in the member; and
positioning the first array of first component spray nozzles such that each of the first component spray nozzles protrudes through an orifice in the member and is adjacent at least one of the second component spray nozzles.

18. A multi-component liquid spray system comprising:
an air chamber defined by a cavity in a housing;
means for producing a first spray of a first component coupled to the housing;
means for delivering the first component in fluid communication with the means for producing the first spray;
means for producing a second spray of a second component coupled to the housing; and
means for delivering the second component in fluid communication with the means for producing the second spray.
